(19) United States
(12) Patent Application Publication
(10) Pub. No.: US 2009/0052928 A1
(43) Pub. Date: Feb. 26, 2009

(54) METHOD FOR OPERATING A PRINTER TO PRINT

(75) Inventor: Hung-Ming Hsu, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: AETAS TECHNOLOGY, INCORPORATED, Irvine, CA (US)

(21) Appl. No.: 11/843,652

(22) Filed: Aug. 23, 2007

(51) Int. Cl. G03G 15/20

(52) U.S. Cl. 399/70

(57) ABSTRACT

A method for operating a printer to print with the operation having a pre-determined period of time between the start of a printing process and the completion of a fuser module heating process is provided. The method includes performing the heating process by heating the fuser module towards a target temperature. Next, compare the rest of the expected period of time for the fuser to arrive at the target temperature with the pre-determined period of time. If the expected period of time is no more than the predetermined period of time, start the printing processes. Lastly fuse the printing medium after the completion of the printing processes. The present invention also includes a method for operating a printer to print with the operation having an adjustable period of time between the start of the printing processes and the completion of a fuser module heating process.

### BACKGROUND

1. Field of Invention

The present invention relates to a method for operating a printer. More particularly, the present invention relates to a method for operating a printer having printing processes ahead of the completion of a fuser module heating process for the fuser module to arrive at a target temperature.

2. Description of Related Art

Nowadays, printers, photo copiers, fax machines, and any kind of machines capable of printing are widely used in any industry and are very common tools for personal use also. In toner-based printers, the printer manufacturers often choose to use cheaper fuser modules such as the soft-soft fuser module for fusing in a printing process. Although the cheaper fuser modules have an advantage in manufacturing costs, however, the trade-off is slower reaction time leading to longer printing time and lower power efficiency due to maintaining the fuser module at a desired temperature for an unnecessary extra period of time.

A typical printing process includes the steps of charging a photosensitive medium, exposing the photosensitive medium with a radiation source to form a latent image, developing the latent image of the photosensitive medium to form a toner image, transferring the toner image onto a printing medium such as paper, and finally fusing the toner image onto the paper.

For example, in toner-based printers, a timing diagram of the conventional printing process from start to finish is as illustrated in FIG. 1. When the printer is turned on and a print command is executed by the user, the fuser module starts to be heated towards a target temperature at the heating stage 102. At the heating stage 102, the rising edge 102a represents the start of the heating, and the falling edge 102b represents the stop of the heating. Notice after the fuser module arrives at the target temperature, the fuser module is heated on and off to maintain the fuser module at the target temperature. After the fuser module is heated to the target temperature, the fuser module enters a fuser ready stage 104. Once the fuser module is in the fuser ready stage 104, the printing processes may begin at the printing stage 106, where the printer starts to perform charging, exposing, developing, takes in the paper and transferring steps as mentioned above. Finally, the fuser module will enter the fusing start stage 108 where the fuser module starts fusing the paper with toner patterns once the printing processes are completed.

From the above sequence of the printing process, one can notice that when the fuser module is in the fuser ready stage 104, which allows the fuser module to start operation, yet due to the time needed for the printing processes to finish, the fuser module will have to wait for the printing processes to finish before the fuser module can start fusing. Therefore, the time for the printing processes delays the overall printing process and also forces the fuser module to be unnecessarily sustained at the target temperature, which leads to power wastage.

For the foregoing reasons, there is a need for a new method for operating a toner-based printer, which reduces the overall printing time of the printing process thus reducing the power wastage.

### SUMMARY

The present invention is directed to a method for operating a printer, that it satisfies this need of reducing the overall printing time of the printing process. The method comprises performing the heating process by heating the fuser module towards a target temperature. A pre-determined period of time, which is the time allowed for the printing process to start in advance before the fuser module reaches the target temperature, is compared with an expected period of time calculated based on an instantaneous temperature of the fuser module. The printing processes may start if the expected period of time is no more than the pre-determined period of time. Lastly, the printing medium may be fused after the completion of the printing processes as the fuser module should be in the fuser ready stage then.

Furthermore, The pre-determined period of time needs to be well defined to compensate for environmental factors, such as ambient temperature, humidity, and pressure, which possibly may cause inaccuracy in the estimation of the time needed for the fuser module to reach the target temperature. Thus, a compensation technique is applied to the method of the present invention. The compensation technique is to determine an adjustable period of time instead of a fixed pre-determined period of time, so that as the ambient condition changes, the adjustable period of time will change based on the actual time difference between the beginning of the fuser ready stage and the beginning of the fusing start stage.

The embodiments of the present invention allows the start of the printing process to overlap the fuser module heating process, so that the printing process starts before the fuser module reaches the target temperature. Therefore, when the fuser module reaches the target temperature, the printing process is near completion and thus the fuser module may start fusing near the instance in time when the fuser module enter the fuser ready stage. Thus, the time difference between the completion of the fuser module heating process and the start of the fusing operation may be minimized to save time and energy.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a timing diagram of the conventional printing process from start to finish;

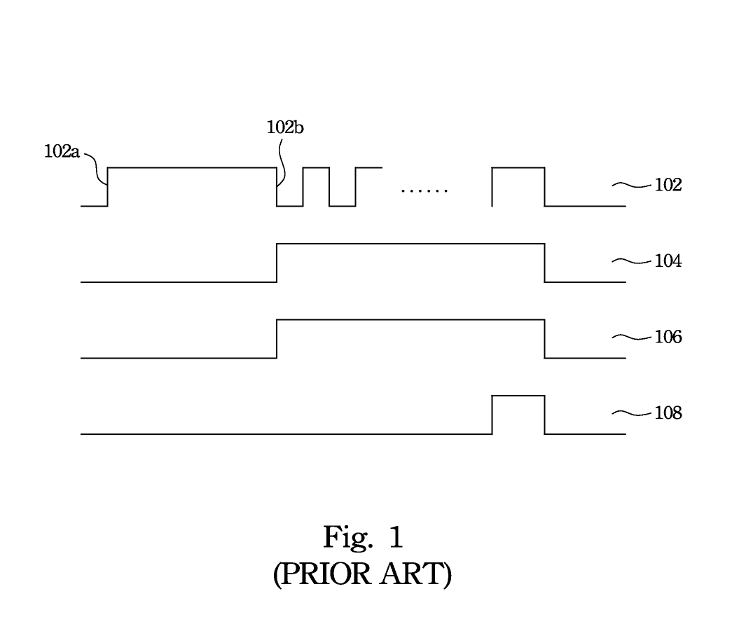

FIG. 2 is a flow chart of the printing process according to a first embodiment of the present invention;

FIG. 3 is a flow chart of the printing process according to a second embodiment of the present invention; and

FIG. 4 is a timing diagram of the printing process from start to finish according to the embodiment of the present invention.

### DESCRIPTION OF THE PREFERRED EMBODIMENTS

Reference will now be made in detail to the present preferred embodiments of the invention, examples of which are illustrated in the accompanying drawings.

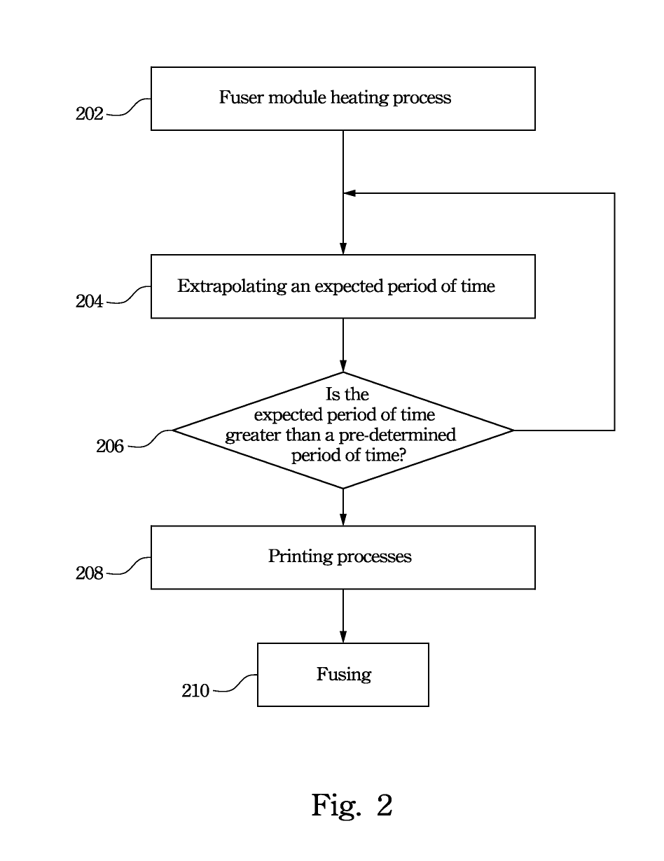

Please refer to FIG. 2, a flow chart of the printing process according to a first embodiment of the present invention. When the user executes the printing command, the fuser module starts heat towards a target temperature, which allows the fuser module to properly perform fusing, in the fuser module heating process 202. As the fuser module is being heated towards the target temperature, the printer measures an instantaneous temperature of the fuser module and extrapolates an expected period of time for the fuser module to reach the target temperature. The extrapolation step 204 is performed by applying an algorithm such as a computer program to calculate how much time is still needed for the fuser module to reach the target temperature based on the detected instantaneous temperature. After the expected period of time is extrapolated, the rest of the expected period of time is compared to a pre-determined period of time at the comparison step 206, which is indicative of the time needed for the printer to reach the target temperature form the start of the -printing processes.

If the rest of the expected period of time is no more than the pre-determined period of time, it indicates that the fuser module will be able to reach the target temperature before the -printing processes are completed, and therefore the printer should start the printing process 208 immediately. However, if the rest of the expected period of time is more than the pre-determined period of time, it indicates that the fuser module will not be able to reach the target temperature upon the completion of the printing processes 208, thus should not begin the printing processes 208 immediately. In the latter condition (the expected period of time greater than the pre-determined period of time), the printer is to loop back to the extrapolation step 204 until an extrapolated expected period of time is less than the pre-determined period of time.

From the above technique, the printing processes 208 should be completed at the time close to the time when the fuser module reaches the target temperature. The fuser module then starts to perform fusing 210. Thus the pre-determined period of time is the time saved by overlapping the fuser module heating process 202 with the printing processes 208 in the time spectrum. In a second embodiment of the present invention, the effect of the ambient environment is taken into consideration. The ambient environment may alter the accuracy of the fuser module temperature based extrapolation as in the first embodiment of the present invention. For example, if the temperature in the ambient environment is much lower than room temperature, the fuser module heating process may require a longer time to reach the target temperature, thus creating an error margin in the calculation of the expected period of time. For this reason, the second embodiment of the present invention provides a method for operating a toner-based printer having an adjustable period of time as the reference time from the start of the printing processes to the time when the fuser module reaches the target temperature. The adjustment is based on the actual time difference between the completion of the fuser module heating process and the start of the fusing process. Therefore, since the goal of the method of the present invention is to minimize the time difference between the completion of the fuser module heating process and the start of the fusing process so that no time is wasted waiting for the printing processes to finish, then the error margin in extrapolation generated by the ambient environment may be compensated by adjusting the adjustable period of time.

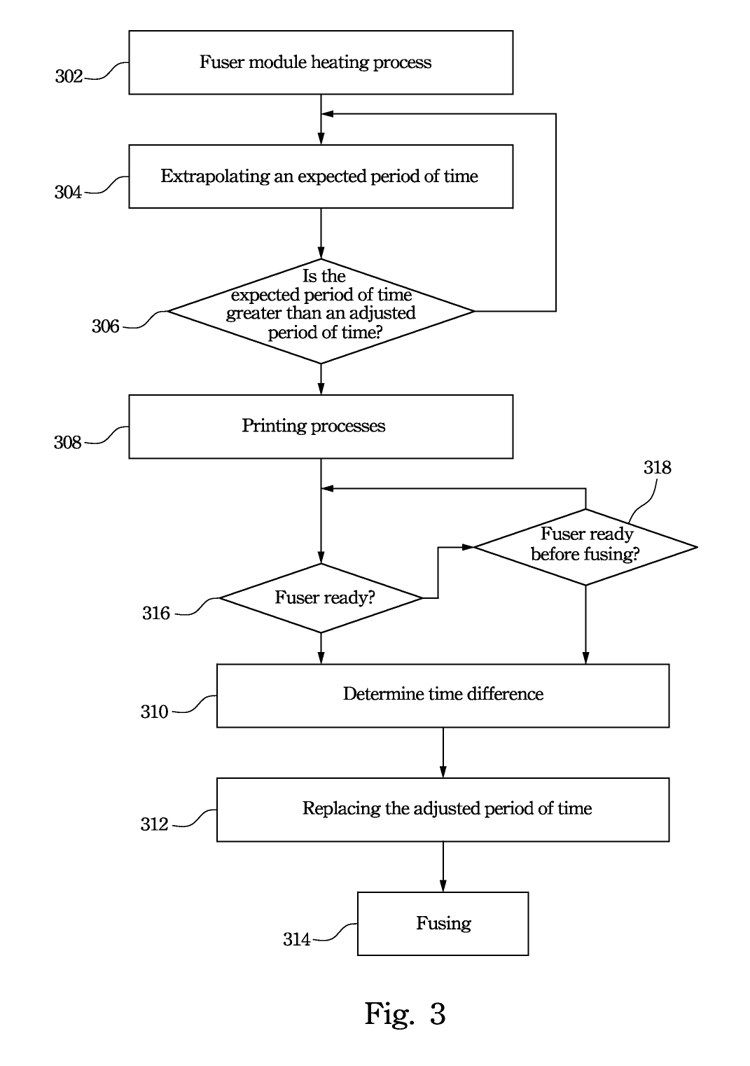

Please refer to FIG. 3, a flow chart of the printing process according to the second embodiment of the present invention. The print process begins by heating the fuser module towards a target temperature in a fuser module heating process 302. As the fuser module is being heated towards the target temperature, the printer measures an instantaneous temperature of the fuser module and extrapolates an expected period of time for the fuser module to reach the target temperature. The extrapolation step 304 is performed by applying an algorithm such as a computer program to calculate how much time is still needed for the fuser module to reach the target temperature based on the detected instantaneous temperature. After the expected period of time is extrapolated, the expected period of time is compared to an adjustable period of time at the comparison step 306, which is indicative of the time needed for the printer to reach the target temperature form the start of the printing processes.

If the expected period of time is no more than the adjustable period of time, it indicates that the fuser module will be able to reach the target temperature before the printing processes are completed, and therefore the printer should start the printing process 308 immediately. However, if the expected period of time is more than the adjustable period of time, it indicates that the fuser module will not be able to reach the target temperature upon the completion of the printing processes 308, thus should not begin the printing processes 308 immediately. In the latter condition (the expected period of time greater than the pre-determined period of time), the printer is to loop back to the extrapolation step 304 until an extrapolated expected period of time is less than the adjustable period of time.

From the above technique, the printing processes 308 should be completed at the time close to the time when the fuser module reaches the target temperature. However, due to possible effect of the ambient environment; before the fuser module starts fusing, the time difference between the completion of the fuser module heating process 302 and the completion of the printing process 308 is determined in step 310. From the time difference, a new adjustable period of time is calculated in step 312 by subtracting the total time needed to complete the printing process with the time difference. The new adjustable period of time replaces the adjustable period of time from the previous printing cycle. After the replacement, the next cycle of printing processes can compare the expected period of time with the new adjusted period of time to compensate for any error margin caused by the ambient environment. In this embodiment, if the ambient environment causes inaccuracy in extrapolating the expected period of time, the initial printing cycle may fail to fuse properly due to the start of fusing while the fuser module has not yet heated to the target temperature, or, the initial printing cycle may not have the optimized adjusted period of time, meaning fusing 314 does not start immediately upon the completion of the fuser module heating process 302.

In order to ensure the fuser module does not fuse with insufficient heating, a fusing failure prevention step 316 is applied to the second embodiment of the present invention for such purpose. In the fusing failure prevention step 316, the fuser module is investigated to determine whether it has reached the target temperature (in the fuser module ready stage) after the printing processes. If the fuser module is ready to begin fusing, then step 310 proceeds. If not, the printer will determine in step 318, whether the fuser module can reach the target temperature before fusing begins in step 314. If the fuser module can reach the target temperature before fusing begins in step 314, then step 310 may also proceed. If not, the printing process will loop back to the beginning of the fusing failure prevention step 316 to ensure the printing process does not proceed with step 310 until the fuser module is heated to the target temperature.

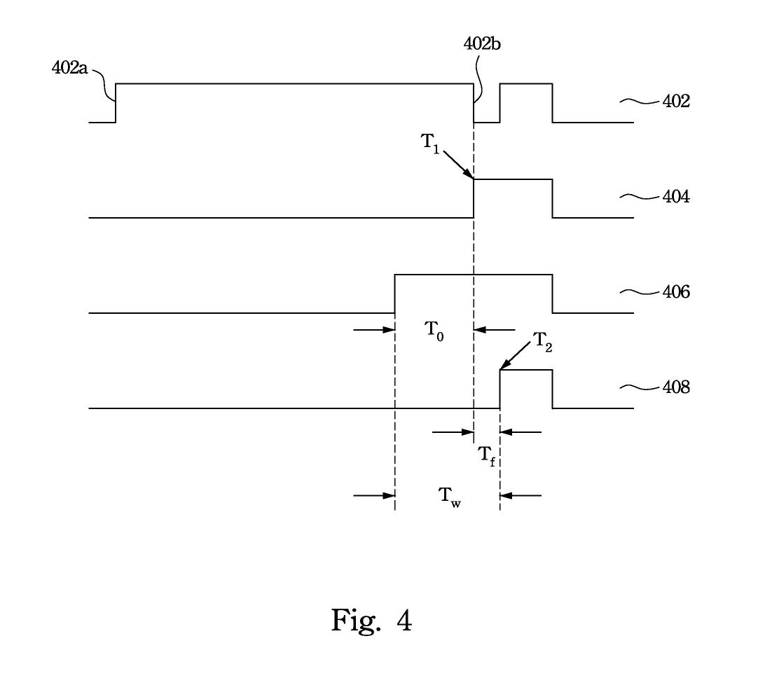

Please refer to FIG. 4, a timing diagram of the printing process from start to finish is provided. When the user executes a print command, the fuser module starts to be heated towards a target temperature at the heating stage 402. At the heating stage 402, the rising edge 402a represents the start of the heating, and the falling edge 402b represents the stop of the heating. The printing process 406 may start before the fuser module enters the fuser ready stage 404 (target temperature reached) by To, which corresponds to the pre-determined or adjustable period of time in the first and second embodiments of the present invention. Once the printing process is completed using a total time of Tw, the printing process may enter the fusing stage 408. The embodiments of the present invention optimizes (shortens) the time Tf, which is the time difference between the completion of the fuser module heating process 202 or 302 and the completion of the printing process 208 or 308. Tf is optimized so that the fuser module can start fusing as soon as the fuser module arrives at the target temperature.

Also from FIG. 4, one may observe that the embodiments of the present invention allows the starting time of the printing processes to ahead of the completion of the fuser module heating process. Thus, from another perspective, the present invention provides a method for operating a printer to print, wherein the operation having a printing process ahead of the completion of a fuser module heating process for the fuser module to arrive at a target temperature. The completion of the fuser module heating process 202 or 302 may be measured at T1, and the completion of the printing process 208 or 308 may be measure at T2. T1 and T2 may be obtained after running a first cycle of print processes.

Therefore, by comparing T₁ and T₂ to get a time period between the T₁ and T₂, which the time period is Tf, the starting time of the printing process may be tuned ahead by at least a difference (To) between Tf and Tw when the T₂ happens later than T₁ and the time period is longer than a minimum time difference between the end of the heating process and the start of the printing processes. On the contrary, the starting time of the printing process may be tuned later by no more than a sum of Tf and the minimum time difference when the T₂ is ahead of T₁. After To is adjusted, the second cycle of the printing processes may use the adjusted To to optimize the total time for the printing processes.

In the above mentioned embodiments, the printing process may include charging a photosensitive medium, exposing the photosensitive medium, developing toner to the photosensitive medium and feeding the printing medium such as paper into the printer.

In actual practice, there may be various modes of printing (black/white, color, photograph . . . etc.), and each mode requires a different total time to complete the printing process. Therefore the method mentioned above may provide a corresponding adjustable period of time to ensure the printer will provide an optimal total time for the entire printing process and thus saves time and provides better energy efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for operating a printer to print, wherein the operation having a pre-determined period of time indicative of the advancement in time for the start of a printing process ahead of the completion of a fuser module heating process, comprising:
performing the heating process by heating the fuser module towards a target temperature in an expected period of time;
comparing a rest of the expected period of time with the pre-determined period of time;
starting the printing processes when the rest of the expected period of time is no more than the predetermined period of time; and
fusing a printing medium after the completion of the printing processes.

2. The method of claim 1, the printing processes at least comprises charging a photosensitive medium, exposing the photosensitive medium to form a latent image on the photosensitive medium, developing the latent image of the photosensitive medium to form a toner image, and transferring the toner image onto the printing medium.

3. The method of claim 1, the method further comprises extrapolating the expected period of time for the fuser module to arrive at the target temperature.

4. The method of claim 3, the method further comprises repeating the extrapolating step when the expected period of time is more than the predetermined period of time.

5. The method of claim 3, wherein the extrapolation is based on an instantaneous temperature of the fuser detected during the heating process.

6. The method of claim 5, wherein the extrapolation is calculated by projecting the time needed to raise the instantaneous temperature to the target temperature.

7. A method for operating a printer to print, wherein the operation having an adjustable period of time indicative of the advancement in time for the start of a printing process ahead of the completion of a fuser module heating process, comprising:
performing the heating process by heating the fuser module towards a target temperature in an expected period of time;
comparing the expected period of time with the adjustable period of time;
starting the printing process when the rest of the expected period of time is no more than the adjustable period of time;
determining a time difference between the completion of the fuser module heating process and the completion of the printing process;
replacing the first period of time by a second period of time according to the time difference; and
fusing a printing medium after the completion of the printing processes.

8. The method of claim 7, the printing processes at least comprises charging a photosensitive medium, exposing the photosensitive medium to form a latent image, developing the latent image on the photosensitive medium to form a toner image, and transferring the toner image onto the printing medium.

9. The method of claim 7, the method further comprises extrapolating the expected period of time for the fuser module to arrive at the target temperature.

10. The method of claim 9, the method further comprises repeating the extrapolating step if the expected period of time is more than the predetermined period of time.

11. The method of claim 9, wherein the extrapolation is based on an instantaneous temperature of the fuser module detected during the heating process.

12. The method of claim 9, wherein the extrapolation is calculated by projecting the time needed to raise the instantaneous temperature of the fuser module to the target temperature.

13. The method of claim 7, the method further comprises determining whether the target temperature is reached by the fuser module upon the completion of the printing process.

14. The method of claim 13, the method further comprises determining whether the target temperature is reachable before the fusing step when the target temperature is not reached by the fuser module.

15. The method of claim 7, wherein second period of time is determined by subtracting a total time needed to complete the printing process with the time difference.

16. A method for operating a printer to print, wherein the operation having a printing process ahead of the completion of a fuser module heating process for the fuser module to arrive at a target temperature, comprising:
running a first cycle of print processes to get a first time T₁ of the end of the fuser module heating process and a second time T₂ of the end of the printing processes;
comparing T₁ and T₂ to get a time period between the T₁ and T₂;
tuning a starting time of the printing process ahead by at least a difference between the time period and the pre-determined time period when the T₂ is later than T₁ and the time period is longer than a pre-determined time period; and
tuning the starting time of the printing process later by no more than a sum of the time period and the pre-determined time period when the T₂ is ahead of T₁.

17. The method of claim 16, wherein the first cycle of the printing processes at least comprises charging a photosensitive medium, exposing the photosensitive medium to form a latent image on the photosensitive medium, developing the latent image to form a toner image, and transferring the toner image onto the printing medium.

18. The method of claim 16, wherein T₁ and T₂ are obtained and compared by a system program of the printer.

19. The method of claim 16, the method further comprises running a second cycle of the printing processes with the tuned starting time of the printing process.

20. The method of claim 16, wherein the pre-determined time period is the time allowed for the printing process to start in advance before the fuser module reaches the target temperature
